(19) United States
(12) Patent Application Publication
(10) Pub. No.: US 2005/0108004 A1
(43) Pub. Date: May 19, 2005

(54) Voice activity detector based on spectral flatness of input signal

(76) Inventors: Takeshi Otani, Kawasaki (JP); Masanao Suzuki, Kawasaki (JP); Yasuji Ota, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/785,238

(22) Filed: Feb. 24, 2004

(30) Foreign Application Priority Data
Mar. 11, 2003 (JP) 2003-064643

(51) Int. Cl. G10L 19/02

(52) U.S. Cl. 704/205

(57) ABSTRACT

A voice activity detector that detects talkspurts in a given signal at a high accuracy, so as to improve the quality of voice communication. A frequency spectrum calculator calculates frequency spectrum of a given input signal. A flatness evaluator evaluates the flatness of this power spectrum by, for example, calculating the average of power spectral components and then adding up the differences between those components and the average. The resultant sum of differences, in this case, is used as a flatness factor of the spectrum. A voice/noise discriminator determines whether the input signal contains a talkspurt or not, by comparing the flatness factor of the frequency spectrum with a predetermined threshold.

### BACKGROUND OF THE INVENTION

1. Field of the Invention

The present invention relates to a voice activity detector, and more particularly to a voice activity detector which discriminates talkspurts from background noises in a given input signal.

2. Description of the Related Art

Recent years have seen an explosive growth in the number of users of mobile communications service such as cellular phone networks. Many powerful functions have been added to mobile handsets, which will enable us to enjoy new multimedia services in the near future.

Mobile communications technologies include speech processing techniques such as voice-operated transmitters (VOX) and noise cancellers. VOX devices use voice energy to turn on the transmitter output. That is, the VOX transmits signals only when there is speech information to send, while shutting off the output during silent periods to save energy. Noise cancellers are devices that selectively suppress noise components in speech signals, thus helping the caller and callee to hear each other's voice even in noisy environments. Both VOX and noise canceller devices have to identify which part of an input signal contains speech information. Such active voice periods, as opposed to noise periods or silent periods, are referred to as “talkspurts.”

A conventional technique for detecting talkspurts is based on the energy level of speech signals. That is, it calculates the power of an input signal and extracts a period with larger power as a talkspurt. The problem of this simple method is that it is prone to erroneous discrimination between speech and noise. To address this deficiency, an improved technique is disclosed in, for example, the Unexamined Japanese Patent Publication No. 60-200300 (1985), pages 3 to 6 and FIG. 5. According to the publication, the energy and spectral envelope of each frame (i.e., a segment with a predetermined time length) of an input signal are extracted as the signal's characteristic properties, and their variations from previous frame to current frame are calculated and compared with a threshold to detect the presence of speech. This detection algorithm, however, has difficulty in discriminating between voice and noise correctly in such conditions where there is intense background noise, or where the voice is very low. In those situations, characteristic properties of talkspurts are less distinguishable from those of noises.

According to another method disclosed in the Unexamined Japanese Patent Publication No. 1-286643 (1989), pages 3 to 4 and FIG. 1, zero-crossings of an input signal is counted to obtain pitch information of the signal. That is, it observes how many times the given signal alternates in sign, and determines the presence of speech by comparing the pitch with an appropriate threshold. This method, however, is unable to discriminate talkspurt period from silence period when the input signal contains a low-frequency component, because the zero-crossing count may vary according to the power of that component.

### SUMMARY OF THE INVENTION

In view of the foregoing, it is an object of the present invention to provide a voice activity detector that detects talkspurts in a given signal at a high accuracy so as to improve the quality of voice communication.

To accomplish the above object, the present invention provides a voice activity detector that detects talkspurts in an input signal. This voice activity detector comprises the following elements: (a) a frequency spectrum calculator that calculates frequency spectrum of the input signal; (b) a flatness evaluator that calculates a flatness factor indicating flatness of the frequency spectrum; and (c) a voice/noise discriminator that determines whether the input signal contains a talkspurt, by comparing the flatness factor of the frequency spectrum with a predetermined threshold.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIGS. 1A and 1B show the concept of a voice activity detector according to the present invention.

FIG. 2 shows a signal power component P[k].

FIG. 3 shows a concept of power spectrum calculation using bandpass filters.

FIGS. 4A to 4C show what equation (2) represents.

FIG. 5 shows an example of frequency responses of bandpass filters.

FIG. 6 shows an example of power spectrum.

FIGS. 7A and 7B illustrate how the flatness of a given signal is evaluated based on the sum of the differences between spectral components and their average.

FIG. 8 shows a power spectrum of a signal.

FIGS. 9A and 9B show how the flatness of a given signal is evaluated based on the sum of squared differences between individual spectral components and their average.

FIGS. 10A and 10B show how the flatness of a given signal is evaluated based on the maximum difference between spectral components and their average.

FIGS. 11A and 11B show how the flatness of a given signal is evaluated based on the sum of the differences between spectral components and their maximum.

FIG. 12 shows how the flatness of a given signal is evaluated based on the sum of differences between adjacent spectral components.

FIG. 13 shows how the flatness of a given signal is evaluated based on the maximum difference between adjacent spectral components.

FIGS. 14A and 14B show how the flatness of a given signal is evaluated based on a threshold obtained from the mean value of a frequency spectrum of the signal.

FIG. 15 illustrates how talkspurts are distinguished from noise periods.

FIG. 16 shows the structure of a VOX system.

FIG. 17 shows the structure of a noise canceller system.

FIG. 18 shows the structure of another noise canceller system.

FIG. 19 shows the structure of a tone detector system.

FIG. 20 shows how to determine tone signal periods.

FIG. 21 shows the structure of an echo canceller system.

FIG. 22 shows a control signal table.

### DESCRIPTION OF THE PREFERRED EMBODIMENTS

Preferred embodiments of the present invention will be described below with reference to the accompanying drawings, wherein like reference numerals refer to like elements throughout.

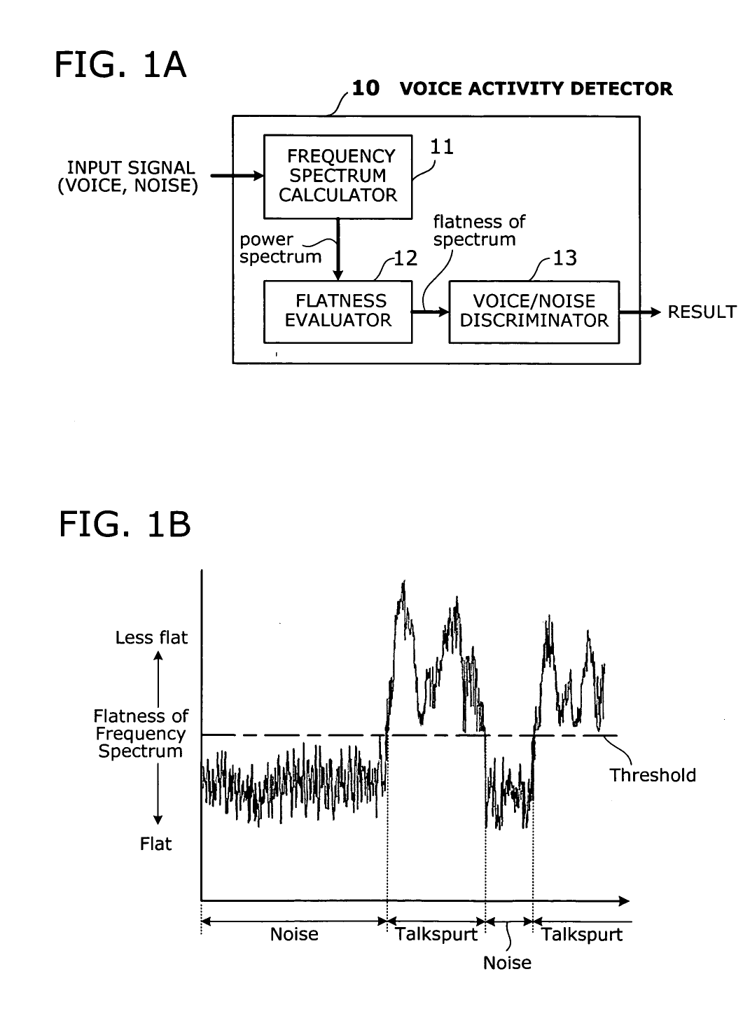

FIG. 1A is a conceptual view of a voice activity detector according to the present invention. This voice activity detector 10 detects talkspurts, namely, speech periods (as opposed to silence periods) in a given signal. To achieve this purpose, it comprises a frequency spectrum calculator 11, a flatness evaluator 12, and a voice/noise discriminator 13.

The frequency spectrum calculator 11 calculates the power spectrum of a given input signal which contains voice components or noise components or both. The power spectrum of a signal shows how its energy is distributed over the range of frequencies. The flatness evaluator 12 evaluates the flatness of this power spectrum, thus producing a flatness factor. The voice/noise discriminator 13 compares the flatness factor of each part of the signal with an appropriate threshold to determine whether that part is voice or noise, thereby detecting talkspurt periods of the input signal.

Referring to FIG. 1B, signal segments with a flatter frequency spectrum are regarded as noise, and signal segments with a less flat frequency spectrum are regarded as speech. The voice activity detector 10 of the present invention identifies talkspurts in a given signal accurately by evaluating the flatness of power spectrum of an input signal to determine whether each segment of the signal contains speech or noise.

### Frequency Spectrum Calculator

We will now describe how the frequency spectrum calculator 11 functions. The frequency spectrum calculator 11 calculates power spectrum (i.e., the distribution of signal power in different frequency bands) of each input signal frame. This can be achieved with either of the following techniques. One technique is to perform a spectral analysis on a whole frame. Another is to first divide a given signal frame into a plurality of frequency components using bandpass filters and then calculate the power of each frequency component. Note here that the proposed voice activity detector 10 deals with signals and their frequency spectrums as discrete data, and therefore, we use the term “spectral component” or “frequency component” throughout this description to refer to a part of signal energy that falls within a finite, discretized frequency range.

In the spectral analysis approach, the power spectrum of a signal is calculated with fast Fourier transform (FFT), wavelet transform, or other known algorithms. In the case of FFT, the Fourier transform algorithm converts a time series of samples into a set of components in the frequency domain, i.e., the frequency spectrum of the signal. Suppose now that a time-domain data stream x for one frame period is given. The given stream is converted to a frequency-domain dataset X=(X[k]|k=1, 2, . . . N), where k is frequency and N is the total number of subdivided (i.e., discretized) frequency bands.

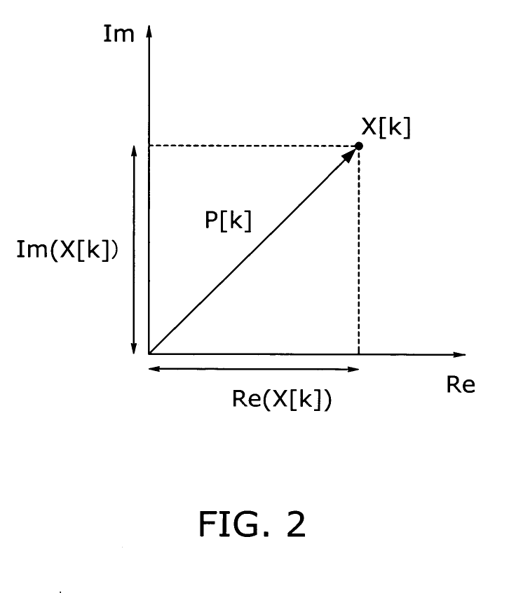

FIG. 2 shows a signal power component P[k] of frequency k. Since X[k] is a complex function, it can be plotted on a complex plane of FIG. 2, where Re denotes the real part and Im denotes the imaginary part. Power P[k] of signal X[k] is equivalent to the squared distance between the origin and X[k], which is expressed as follows:
P[k]=(Re(X[k]))²+(Im(X[k])² (k=1, 2, . . . , N) (1)

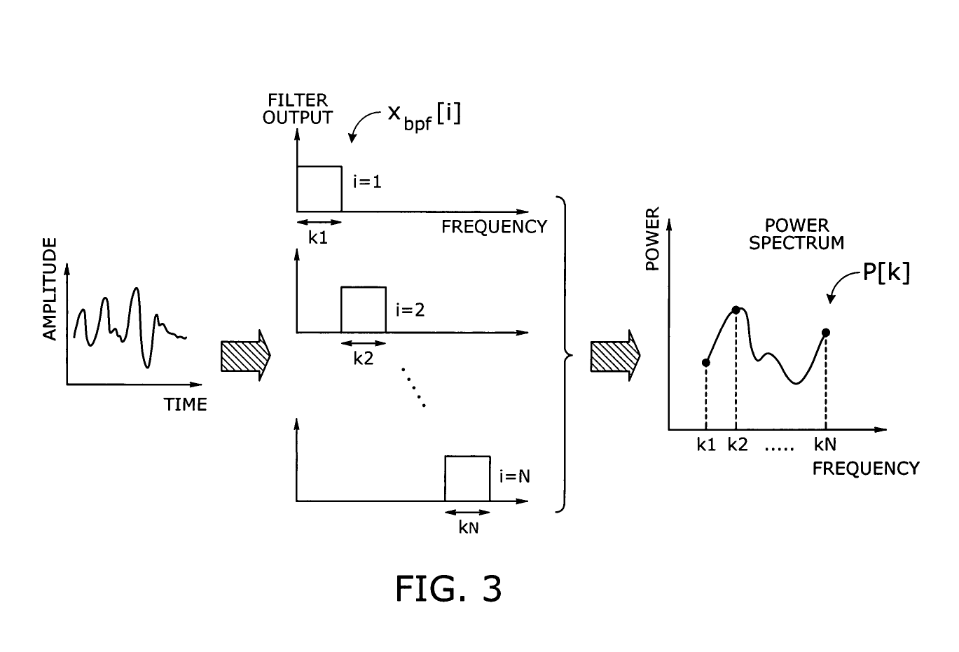

As mentioned, power spectrum can also be obtained by using bandpass filters to divide the signal into frequency components for power calculation. FIG. 3 depicts this alternative method. Specifically, a given input signal frame is directed to a plurality (N) of bandpass filters with different pass bands k1 to kN to yield a set of signal components x_{bpf}[i], where i is the frequency band number (1<i<N). The power spectrum is then obtained through the calculation of P[k] for each of the divided frequency bands. The bandpass filters used in this process may be finite impulse response (FIR) filters. Let x[n] be a time-domain input signal and bpf[i] [j] be a set of bandpass filter coefficients. Then each filtered signal x_{bpf}[i] [n] is given by the following equation (2).

$${x}_{bpf} [ i ] [ n ] = {\sum }_{j} bpf [ i ] [ j ] * x [ n - j ] \qquad ( 2 )$$

where i is frequency band number, j is sampling point number, and n is time step number.

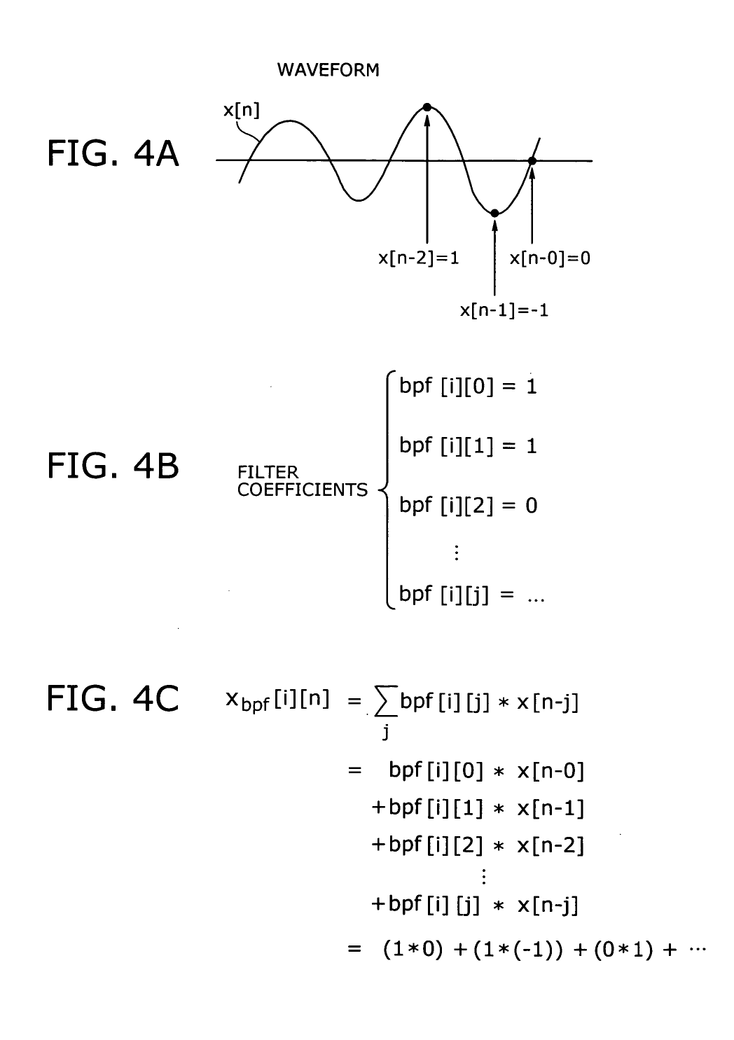

FIGS. 4A to 4C visualize what Equation (2) means. More specifically, FIG. 4A shows an example of a signal waveform x[n], where the signal x[n-0] at sampling point j=0 is zero in amplitude, x[n-1] at sampling point j=1 is −1, and x[n-2] at sampling point j=2 is 1. FIG. 4B shows an example of bandpass filter coefficients bpf[i][j], which are: bpf[i] [O]=1 at j=O, bpf[i] [1]=1 at j=1, bpf[i] [2]=0 at j=2, and so on. The general expression of the output x_{bpf}[i] [n] of this FIR filter is given in equation (2), which is the sum of products of signal amplitudes at a series of sampling points and filter coefficients. FIG. 4C shows the i-th frequency band output of the example waveform of FIG. 4A.

Frequency response of the above FIR bandpass filter is given by the following equation:
amp_{BPF}[i][k]=\sqrt{(real[i][k])²+(imag[i][k])²} (3)
where real[i] [k] and imag[i] [k] are:

$$\begin{matrix}real [ i ] [ k ] = {\sum }_{j} ( bpf [ i ] [ j ] * cos ( \frac{2 π \cdot k \cdot j}{N} ) ) & ( 4 a ) \\ imag [ i ] [ k ] = {\sum }_{j} ( bpf [ i ] [ j ] * sin ( \frac{2 π \cdot k \cdot j}{N} ) ) & ( 4 b )\end{matrix}$$

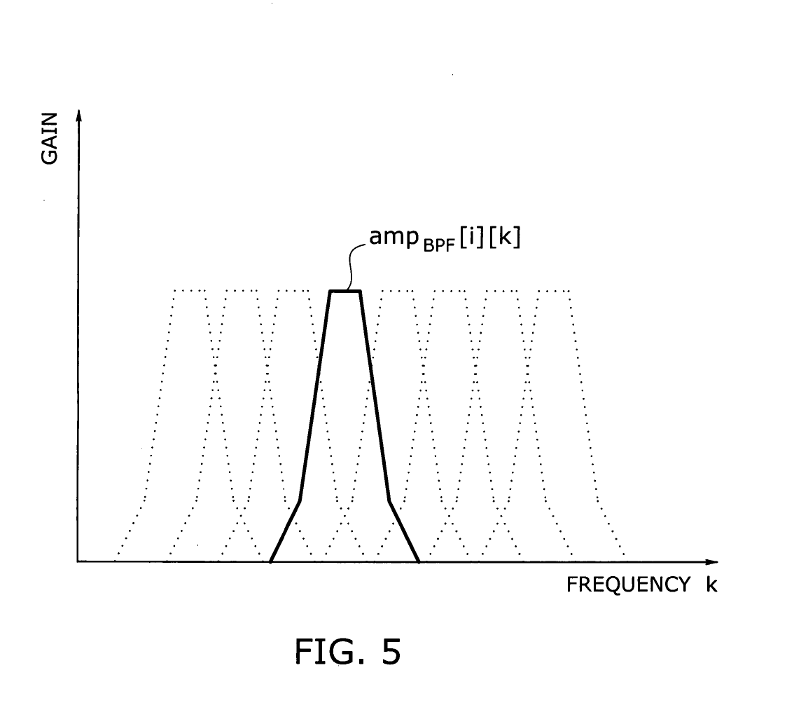

FIG. 5 shows an example of frequency responses of bandpass filters, where the vertical axis represents gain and the horizontal axis represents frequency. The solid line indicates the response of a single bandpass filter. The frequency spectrum calculator 11 includes i instances of such filters indicated by the dotted lines.

The power P[k] of the k-th frequency component extracted by a bandpass filter is calculated as the square sum of x_{bpf}[k][n] (k=1, 2, . . . N), where N is the number of divided frequency bands. This calculation is expressed as

$$\begin{matrix}P [ k ] = {\sum }_{n} {( {x}_{bpf} [ k ] [ n ] )}^{2} \\ ( k = 1 , 2 , … , N )\end{matrix} \qquad ( 5 )$$

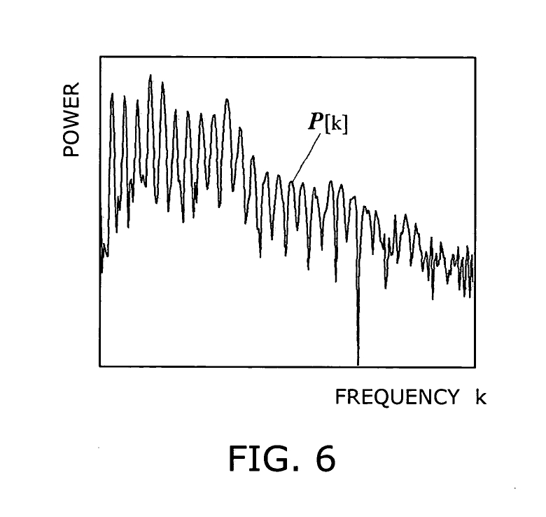

We have described how the power-frequency distribution can be obtained either through spectral analysis or by using bandpass filters. Shown in FIG. 6 is an example of a power spectrum calculated in the described way.

### Flatness Evaluator

This section will describe how the flatness evaluator 12 functions. The role of the flatness evaluator 12 is to determine the flatness of a power spectrum that the frequency spectrum calculator 11 has calculated. To this end, the flatness evaluator 12 uses either one of the following algorithms A1 to A11. Given a signal for one frame period, those algorithms examine the signal in its entire frequency range, or alternatively, in a particular frequency range.

(1) Algorithm A1

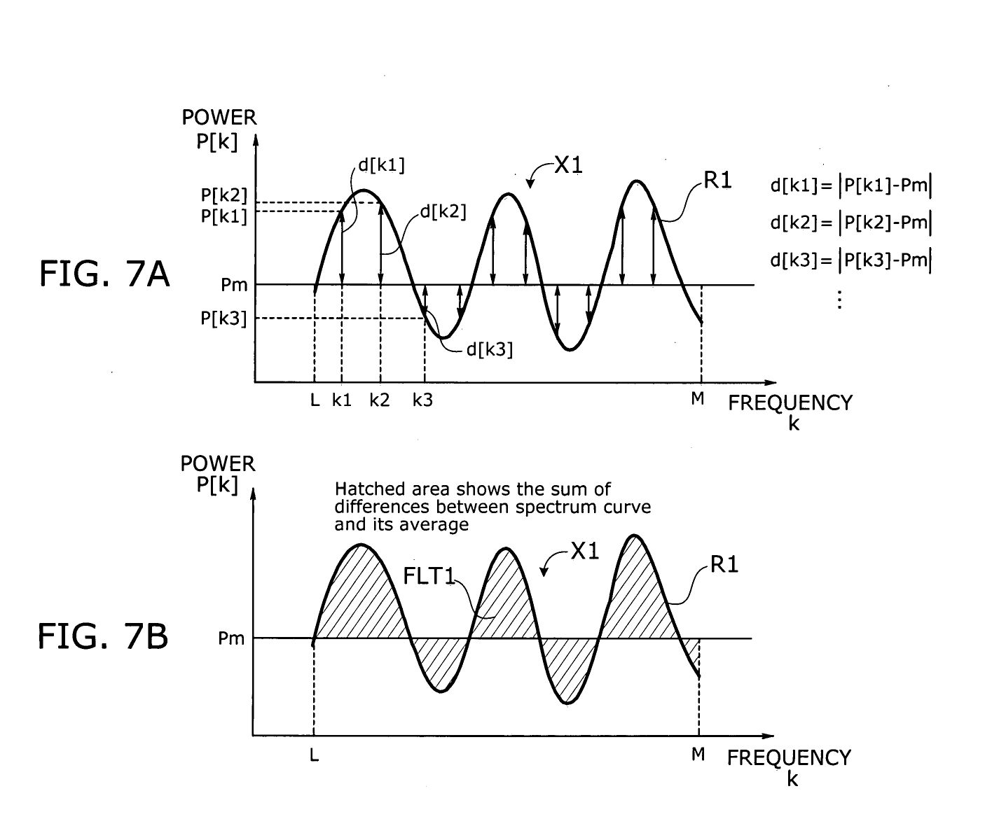

Algorithm A1 calculates the average of given power spectral components and then adds up the differences between those components and their average. The resultant sum indicates the flatness of the spectrum. FIGS. 7A and 7B explain this algorithm A1 in a simplified manner, where the horizontal axes represent frequency k and the vertical axes represent power P[k]. The solid curves show the power spectrum R1 of a signal X1. Pm denotes the average power level of the spectrum R1, and L and M are the lower and upper ends of the frequency range.

Let d[k] denote the difference between the average Pm and each spectral component. For example, the difference d[k1] at frequency k1 is expressed as |P[k1]-Pm|. Likewise, d[k2] is |P[k2]-Pm|, and d[k3] is |P[k3]Pm|. The sum of such differences d[k] in the frequency range between L and M is nearly equal to the hatched area shown in FIG. 7B (actually, some amount of errors exist because of the discretization of R1). That is, the hatched area indicates the flatness factor FLT1 of the signal X1.

The following equation (6) gives the average Pm mentioned above, where L and M are the lower and upper ends of the frequency range of interest, and “avg( )” is the operator for calculating a mean value of given arguments.

$$Pm = {avg}_{k = L}^{M} ( P [ k ] ) \qquad ( 6 )$$

The flatness factor FLT of P[k] is expressed as

$$FLT = {\sum }_{k = L}^{M} ( \vert P [ k ] - Pm \vert ) \qquad ( 7 )$$

Talkspurt periods can be distinguished from noise periods by calculating the flatness of a power spectrum in the way described above. The following will explain how the spectral flatness varies depending on whether the signal contains speech or only background noise.

It is generally known that speech signals have different spectral envelopes and pitch structures, which result in uneven distribution of frequency components. Spectral envelopes represent the timbre of voice, which is determined by the shape of a speaker's vocal tract (i.e., structure of organs from vocal chords to mouth). A change in the shape of a vocal tract affects its transfer function including resonance characteristics, thus causing uneven distribution of acoustic energies over frequency. Pitch structures indicate the tone height, which comes from the frequency of vocal chord vibration. A temporal change in the pitch structure gives a particular accent or intonation in speech. Background noises, on the other hand, are known to have a relatively uniform spectrum. For this reason, white noise approximation or pink noise approximation is often made to represent them.

As can be seen from the above explanation, a signal frame is less likely to exhibit a flat spectrum when it contains speech components, and more likely to have a flat spectrum when it contains background noises only. The voice activity detector 10 of the present invention detects talkspurts using this nature of speech signals in the presence of background noises.

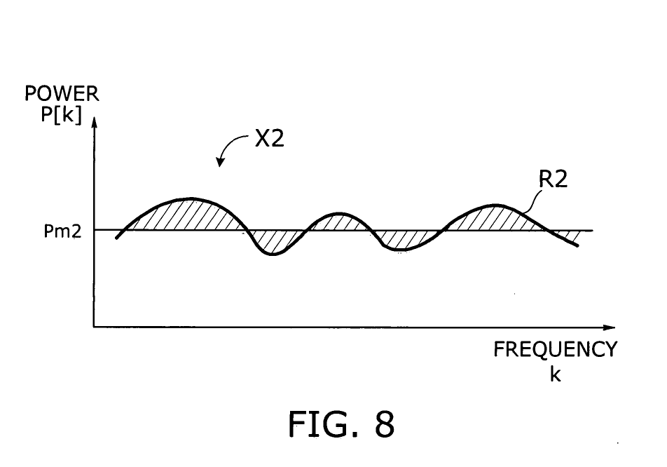

FIG. 8 shows a power spectrum R2 of a signal X2, where the horizontal axis represents frequency k, the vertical axis represents signal power P[k], and Pm2 denotes the average power level of R2. The frequency components P[k] of signal X2 are distributed within a relatively narrow range around their average Pm2, meaning that this signal X2 is regarded as noises. The sum of differences of those frequency components from the average Pm2 is equivalent to the hatched area in FIG. 8, which indicates the flatness factor FLT2 of signal X2.

The flatness factor FLT1 of signal X1 (FIG. 7) is obviously greater than FLT2 of signal X2 (FIG. 8). This fact indicates that the signal X1 is speech while the signal X2 is noise. Note here that a larger value of FLT means a less flat spectrum, and that a smaller value of FLT means a flatter spectrum. Talkspurts can be identified by calculating flatness factors of spectrums and comparing them (the voice/noise discriminator 13 actually compares the flatness factor with a predetermined threshold).

(2) Algorithm A2

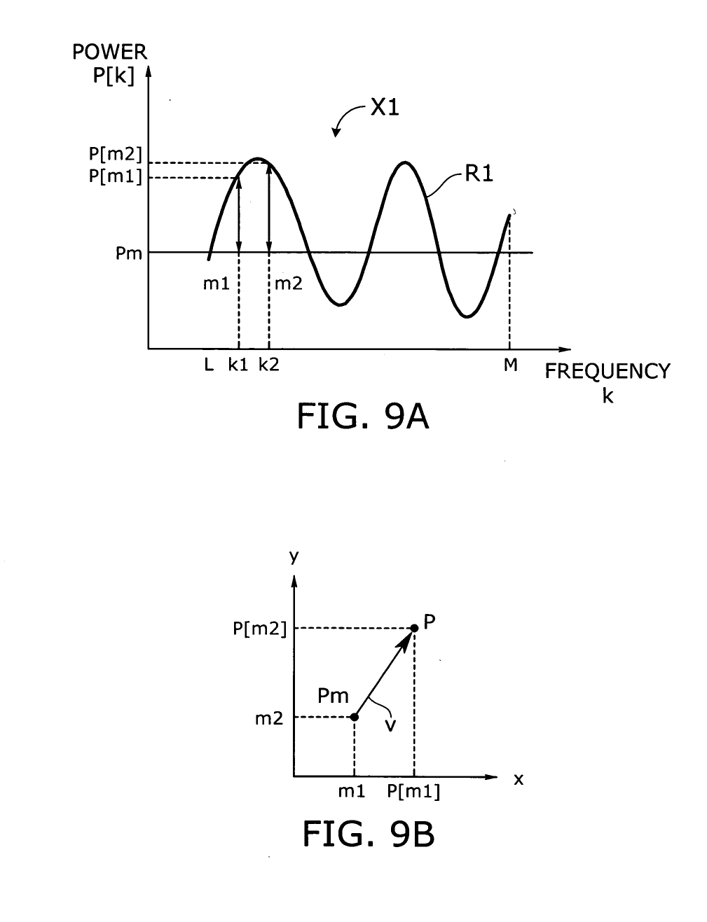

Algorithm A2 calculates the average of given power spectral components and then adds up the squared differences between individual spectral components and the average. The resultant sum is used as the flatness factor of the spectrum. FIGS. 9A and 9B explain this algorithm A2 in a simplified manner. Specifically, FIG. 9A shows the power spectrum R1 of a signal X1, where the horizontal axis represents frequency k and the vertical axis represents power P[k]. To calculate the squared differences between frequency components and their average is to calculate the length of a vector directing from the average line to a point on the spectrum curve. Consider, for example, that the frequency spectrum has a component with power P[m1] and average m1 at frequency k1 and a component with power P[m2] and average m2 (=m1) at frequency k2. Then plot two points (m1, m2) and (P[m1], P[m2]) on the plane where the x axis represents m1 and the y axis represents m2. This results in a vector v shown in FIG. 9B, the length of which is ((P[m1]−m1)²+(P[m2]−m2)²)^{1/2}. Flatness factor FLT is obtained as the sum of such vector lengths, which are calculated by repeating the above operation for all N spectral components. This process is expressed in the following equation (8).

$$FLT = {\sum }_{k = L}^{M} {( \vert P [ k ] - Pm \vert )}^{2} \qquad ( 8 )$$

Note here that there is no square-root operator in equation (8), because the algorithm compares flatness factors in a relative sense, rather than evaluating their absolute magnitudes. With algorithm A2, flatness factors FLTv of talkspurt periods are greater than flatness factors FLTn of noise periods (i.e., FLTv>FLTn).
(3) Algorithm A3

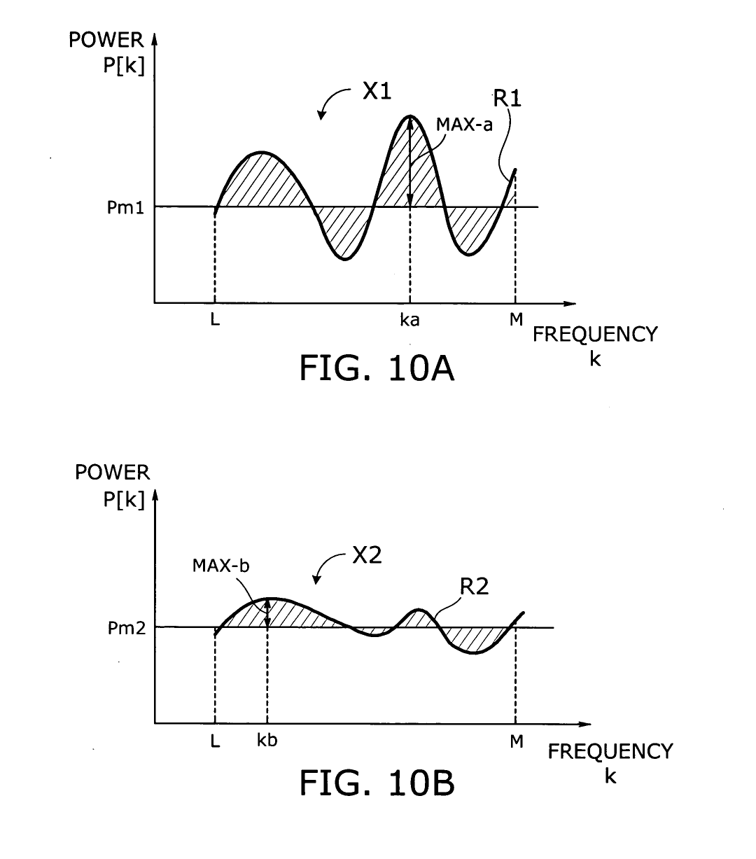

Algorithm A3 calculates the average of given power spectral components and then finds a maximum difference from the average as the flatness factor of the spectrum. FIGS. 10A and 10B explain this algorithm A3 in a simplified manner. More specifically, FIGS. 10A and 10B show the power spectrums R1 and R2 of two signals X1 and X2, respectively, where the horizontal axes represent frequency k and the vertical axes represent power P[k]. The first spectrum R1 has a maximum difference MAX-a from its average Pm1 at frequency ka, while the second spectrum R2 has a maximum difference MAX-b from its average Pm2 at frequency kb. Flatness factors FLT of those two spectrums R1 and R2 are thus MAX-a and MAX-b, respectively.

The following equation (9) represents the above calculation.

$$FLT = {max}_{k = L}^{M} ( \vert P [ k ] - Pm \vert ) \qquad ( 9 )$$

With algorithm A3, flatness factors FLTv of talkspurt periods are greater than flatness factors FLTn of noise periods (i.e., FLTv>FLTn).
(4) Algorithm A4

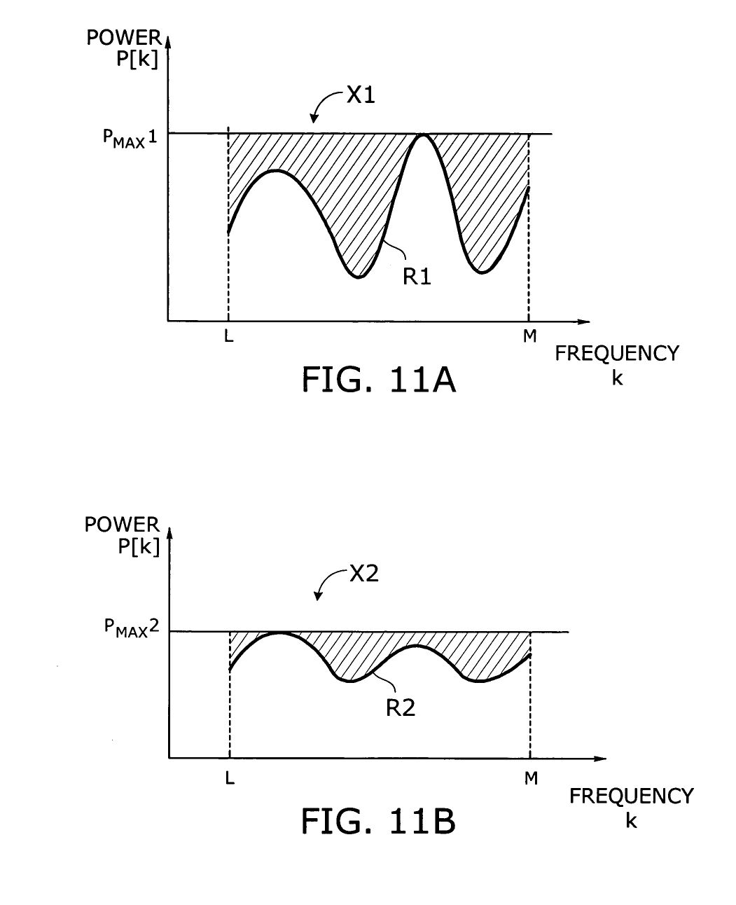

Algorithm A4 finds a maximum value of a given power spectrum and then adds up the differences between individual spectral components and the maximum. The resultant sum is the flatness factor of the spectrum. FIGS. 11A and 11B explain this algorithm A4 in a simplified manner. More specifically, FIG. 11A and 11B show the power spectrums R1 and R2 of two signals X1 and X2, respectively, where the horizontal axes represent frequency k and the vertical axes represent power P[k]. P_{MAX}1 and P_{MAX}2 are maximum values of the spectrums R1 and R2. Algorithm A4 takes the maximum of a given spectrum as the reference level, unlike the preceding three algorithms A1 to A3, which use the average value of a spectrum for that purpose. The same concept applies to other algorithms A5 and A6 as will be described subsequently.

The area between the spectrum curve (e.g., the hatched area in FIG. 11A) and the line of P[k]=P_{MAX} (maximum power level) is equivalent to the sum of the differences between spectral components and their maximum value. This area is regarded as the flatness factor FLT. The following equations (10) and (11) give the maximum value P_{MAX} of P[k] and the flatness factor FLT, respectively.

$$\begin{matrix}{P}_{MAX} = {max}_{k = L}^{M} ( P [ k ] ) & ( 10 ) \\ FLT = {\sum }_{k = L}^{M} ( \vert P [ k ] - {P}_{MAX} \vert ) & ( 11 )\end{matrix}$$

With algorithm A4, flatness factors FLTv of talkspurt periods are greater than flatness factors FLTn of noise periods (i.e., FLTv>FLTn).
(5) Algorithm A5

Algorithm A5 finds a maximum value of a given power spectrum and then adds up the squared differences between individual spectral components and the maximum. The resultant sum is regarded as the flatness factor of the spectrum. This operation of algorithm A5 is expressed as follows.

$$FLT = {\sum }_{k = L}^{M} {( \vert P [ k ] - {P}_{MAX} \vert )}^{2} \qquad ( 12 )$$

Recall that the foregoing algorithm A2 uses the average of a given spectrum as the reference level. Unlike that algorithm A2, the algorithm A5 references to the maximum value of a given spectrum. Despite this dissimilarity, two algorithms A2 and A5 share the basic concept and procedure, and we therefore omit the details of algorithm A5.
(6) Algorithm A6

Algorithm A6 finds a maximum value of a given power spectrum and then seeks the maximum difference between individual spectral components and that maximum value. The resultant sum is regarded as the flatness factor of the spectrum. Unlike the foregoing algorithm A3, which evaluates a given spectrum based on its the average, the present algorithm A6 references to the maximum of a given spectrum. Despite this difference, the two algorithms A3 and A6 share the basic concept and procedure, and we therefore omit the details of algorithm A6, except for showing the equation for calculating flatness factor FLT.

$$FLT = {max}_{k = L}^{M} ( \vert P [ k ] - {P}_{MAX} \vert ) \qquad ( 13 )$$

(7) Algorithm A7

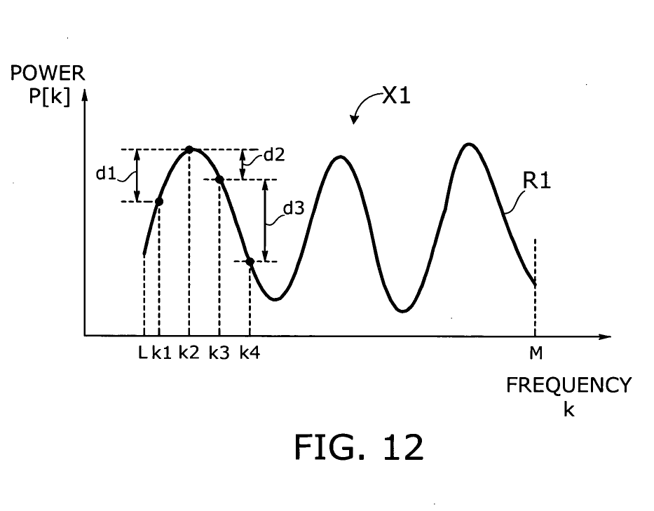

Algorithm A7 adds up the differences between adjacent frequency components of a given spectrum and uses the resultant sum as the flatness factor. FIG. 12 explain this algorithm A7 in a simplified manner. Specifically, FIG. 12 shows the power spectrum R1 of a signal X1, where the horizontal axis represents frequency k and the vertical axis represents power P[k]. The difference d1 between the first and second components P[k1] and P[k2] is calculated, and then the difference between the second and third components P[k2] and P[k3] is calculated. Likewise, the difference d3 between the third and fourth components P[k3] and P[k4] is calculated. Repeating such subtractions throughout the frequency range, the algorithm adds up the differences to yield a flatness factor FLT according to the following equation.

$$FLT = {\sum }_{k = L}^{M - 1} ( \vert P [ k ] - P [ k + 1 ] \vert ) \qquad ( 14 )$$

With algorithm A7, flatness factors FLTv of talkspurt periods are greater than flatness factors FLTn of noise periods (i.e., FLTv>FLTn). That is, voice spectrums generally exhibit a larger power variation from one frequency to another, in comparison with noise spectrums, and this nature justifies the use of FLT of equation (14) to discriminate talkspurts from background noises.

(8) Algorithm A8

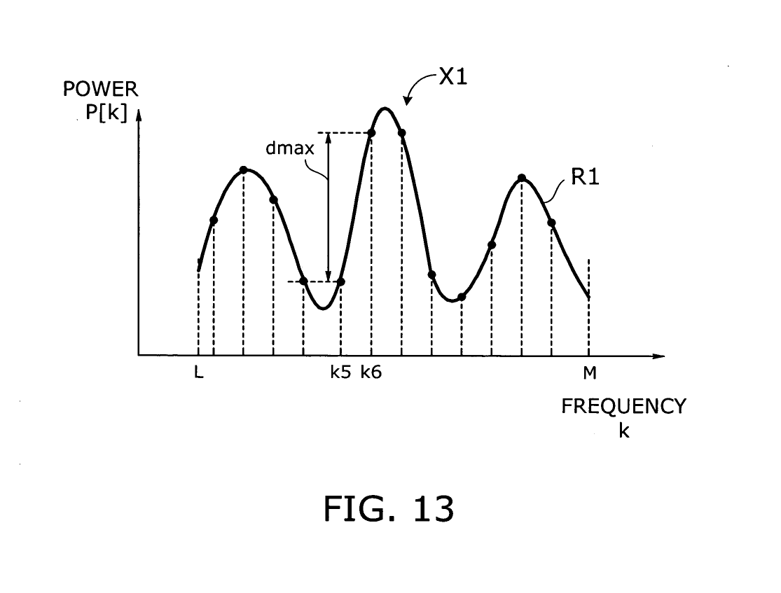

Algorithm A8 finds a maximum difference between adjacent frequency components of a given spectrum and uses it as the flatness factor. FIG. 13 explains this algorithm A8 in a simplified manner. More specifically, FIG. 13 shows the power spectrum R1 of a signal X1, where the horizontal axis represents frequency k and the vertical axis represents power P[k]. Suppose, for example, that the spectrum R1 gives a maximum difference at the point between frequencies k5 and k6. The flatness evaluator 12 regards this difference as a flatness factor FLT. The above process is expressed as

$$FLT = {max}_{k = L}^{M - 1} ( \vert P [ k ] - P [ k + 1 ] \vert ) \qquad ( 15 )$$

With algorithm A8, flatness factors FLTv of talkspurt periods are greater than flatness factors FLTn of noise periods (i.e., FLTv>FLTn).
(9) Algorithm A9

Algorithm A9 introduces a normalizing step to the preceding algorithms A1 to A8. That is, the flatness factor obtained with one of the algorithms A1 to A8 is then divided by the average of frequency components (i.e., the average power of a given frame). The resultant quotient is a normalized version of the flatness factor.

The foregoing algorithm A8, for example, seeks the maximum difference between adjacent spectral components in a given frame signal. Because the magnitude of voices may vary, a louder voice tends to surpass a lower voice in terms of the maximum difference observed in them, regardless of their actual spectral flatness. It is therefore necessary to decouple flatness factors from the loudness of voice. The normalization of flatness factors permits the subsequent voice/noise discriminator 13 to find talkspurts more accurately, no matter how loud the voice is. The divisor in this case is the magnitude of voice, which is obtained as the average of a given power spectrum, or the average power of a given signal frame.

(10) Algorithm A10

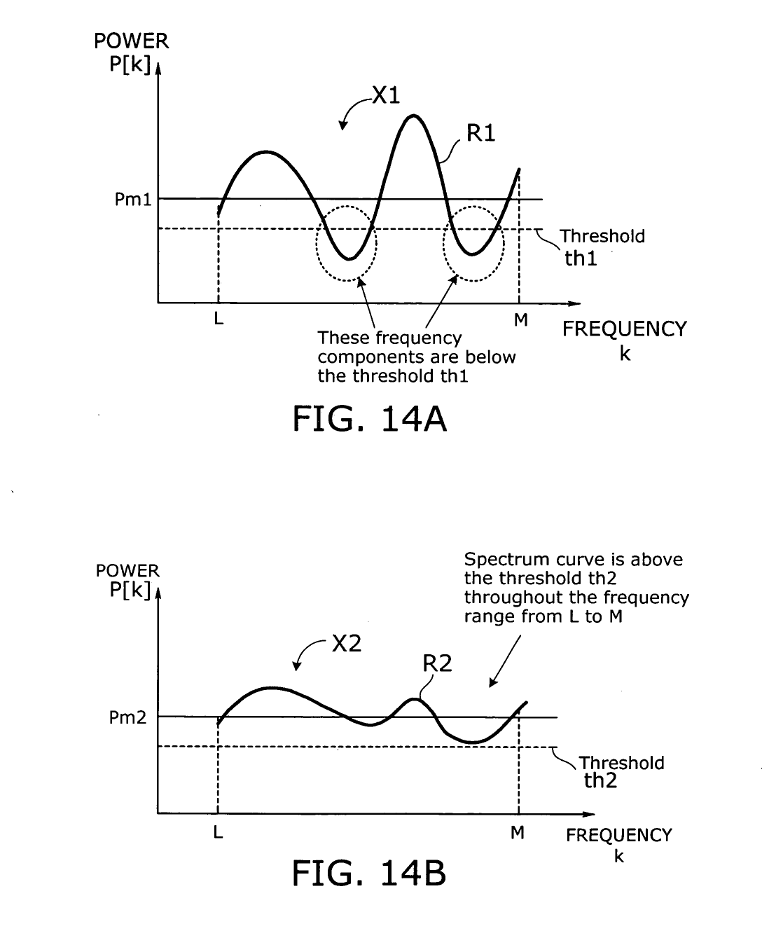

Algorithm A10 determines a threshold by adding a predetermined value to the average of frequency components of a given spectrum, or by multiplying the average by a predetermined factor, and then enumerates the frequency components that exceed the threshold. The resulting count is used as the flatness factor of the spectrum. FIGS. 14A and 14B explain this algorithm A10 in a simplified manner. More specifically, FIGS. 14A and 14B show the power spectrums R1 and R2 of two signals X1 and X2, where the horizontal axes represent frequency k and the vertical axes represent power P[k]. Referring to FIG. 14A, the spectrum R1 has an average power of Pm1, and a threshold th1 is calculated either by adding a predetermined constant value to Pm1 or by multiplying Pm1 by a predetermined constant value. In the present example, the threshold th1 is set slightly below the average Pm1 as shown in FIG. 14A, and the spectrum R1 falls below this th1 in some frequency bands. Comparison of each spectral component with respect to the threshold th1 yields the number of such components that exceed th1. This is the flatness factor FLT1 of the spectrum R1.

Referring to FIG. 14B, the spectrum R2 has an average power of Pm2, and a threshold th2 is calculated either by adding a predetermined constant value to Pm2 or by multiplying Pm2 by a predetermined constant value. In the present example, the threshold th2 is set slightly below the average Pm2 as shown in FIG. 14B, and the spectrum R2 are above this th2 throughout the frequency range. Comparison of each spectral component with respect to the threshold th2 yields the number of such components that exceed th2. This is the flatness factor FLT2 of the spectrum R2.

As can be seen from FIGS. 14A and 14B, the flatness factor FLT1 of R1 is obviously greater than the flatness factor FLT2 of R2. That is, most components of a flatter spectrum exceed the threshold, and signals having this type of spectrum are considered to be noise. Note that, with algorithm A10, flatness factors FLTv of talkspurt periods are smaller than flatness factors FLTn of noise periods (i.e., FLTv<FLTn), unlike the preceding algorithms A1 to A9.

The above-described calculation is expressed in the following equations:

$$\begin{matrix}FLT = {count}_{k = L}^{M - 1} ( P [ k ] > THR ) & ( 16 ) \\ THR = Pm * COEFF & ( 17 a ) \\ THR = Pm + CONST & ( 17 b )\end{matrix}$$

where “count( )” is an operator for counting the number of events that satisfy the conditions specified in the argument. The threshold value THR is given by either equation (17a) or (17b), where COEFF is a multiplication factor for (17a) and CONST is a constant for addition in (17b).
(11) Algorithm A11

Algorithm A11 determines a threshold by adding a predetermined value to the maximum frequency component in a given spectrum, or by multiplying the same by a predetermined factor, and then enumerates the frequency components that exceed the threshold. The resulting count is used as the flatness factor of the spectrum. Unlike the preceding algorithm A10, algorithm A11 references to the maximum value of a given spectrum, not to the average of the same. Despite this dissimilarity, the two algorithms A10 and A11 share their basic concept and procedure, and we therefore omit the details of algorithm A11, except for the following equations for flatness factor FLT and threshold THR.

$$\begin{matrix}FLT = {count}_{k = L}^{M - 1} ( P [ k ] > THR ) & ( 18 ) \\ THR = {P}_{MAX} * COEFF & ( 19 a ) \\ THR = {P}_{MAX} + CONST & ( 19 b )\end{matrix}$$

### Voice/Noise Discriminator

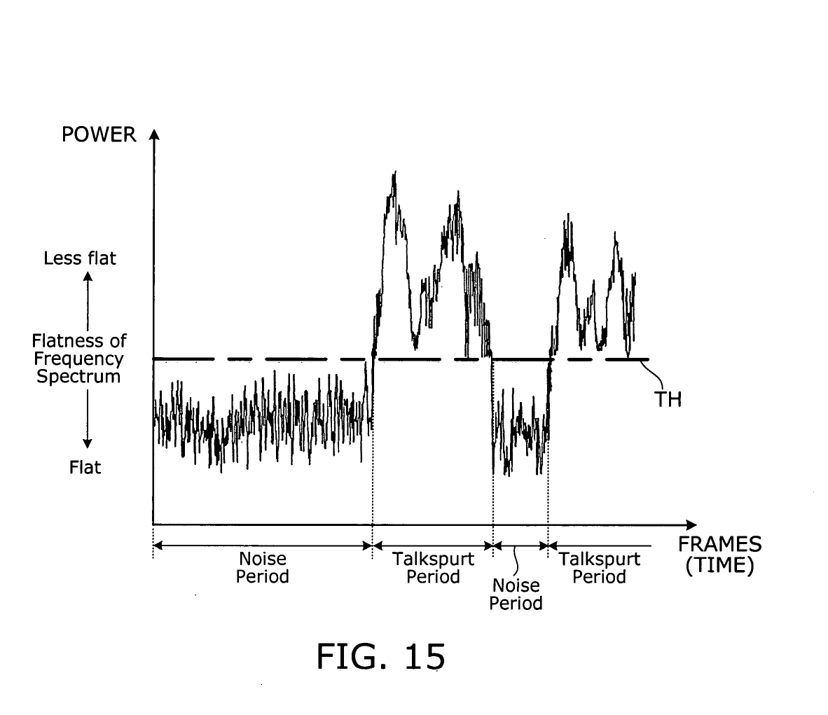

This section describes the voice/noise discriminator 13 in greater detail. The voice/noise discriminator 13 receives a flatness factor from the flatness evaluator 12. The role of the voice/noise discriminator 13 is to determine whether the given signal frame is a talkspurt period or a noise period, by comparing the received flatness factor with a predetermined threshold. It sets an appropriate flag to indicate the result. FIG. 15 illustrates how talkspurts are differentiated from noise periods, where the horizontal axis represents frames (time) and the vertical axis represents signal power. With reference to an appropriate threshold TH, the voice/noise discriminator 13 achieves separation between talkspurt periods and noise periods.

### VOX Applications

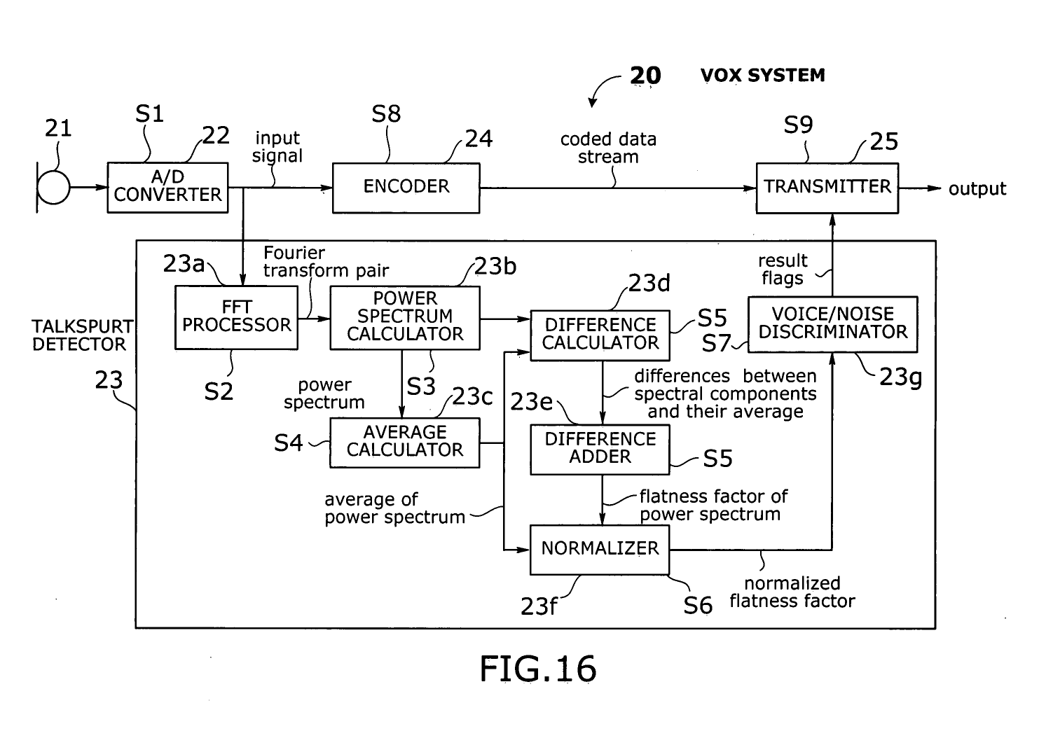

This section explains a specific application of the proposed voice activity detector. FIG. 16 shows the structure of a voice-operated transmitter (VOX) system according to the present invention. The illustrated VOX system 20 analyzes a given signal frame to detect the presence of speech components. VOX turns on and off its transmitter output depending on whether a speech signal is present or not, so as to prevent the transmitter from wasting electrical power. The VOX system 20 of FIG. 16 is designed to calculate a power spectrum with FFT algorithms, evaluate the flatness of the spectrum on the basis of equation (7), and normalize the flatness value in the way described earlier in Algorithm A9.

More specifically, the illustrated VOX system 20 comprises the following elements: a microphone 21, an analog-to-digital (A/D) converter 22, a talkspurt detector 23, an encoder 24, and a transmitter 25. Note that the voice activity detector 10 of FIG. 1 is applied to the talkspurt detector 23, which is formed from the following elements: an FFT processor 23a, a power spectrum calculator 23b, an average calculator 23c, a difference calculator 23d, a difference adder 23e, a normalizer 23f, and a voice/noise discriminator 23g.

To be more specific about the relationship between FIG. 1 and FIG. 16, the FFT processor 23a and power spectrum calculator 23b provide the functions of the frequency spectrum calculator 11 described in FIG. 1. The average calculator 23c, difference calculator 23d, difference adder 23e, and normalizer 23f serve as the flatness evaluator 12. The voice/noise discriminator 23g is equivalent to the voice/noise discriminator 13.

The VOX system 20 of FIG. 16 operates as follows:
(S1) The microphone 21 supplies a voice signal to the A/D converter 22. The A/D converter 22 converts the input signal into digital form.
(S2) The FFT processor 23a analyzes each frame (i.e., predetermined time period) of a given input signal by using FFT algorithms, thus decomposing it into individual frequency components.
(S3) The power spectrum calculator 23b produces a power spectrum by calculating the power of frequency components of each input signal frame.
(S4) According to equation (6), the average calculator 23c calculates the average of the power spectrum.
(S5) The difference calculator 23d calculates the difference between each spectral component and the average. The difference adder 23e sums up those differences according to equation (7), thus yielding a flatness factor of each frame.
(S6) The normalizer 23f normalizes the obtained flatness factor by dividing it by the average of the power spectrum.
(S7) The voice/noise discriminator 23g compares the normalized flatness factor of each frame with a predetermined threshold, thereby determining whether the frame in question contains speech or noise. The voice/noise discriminator 23g sets an appropriate flag to indicate the result. It sets, for example, a talkspurt flag if the given flatness factor exceeds the threshold, and a noise flag otherwise.
(S8) The encoder 24 performs speech coding on the given input signal, thus producing a coded data stream.
(S9) The transmitter 25 receives a coded data stream from the encoder 24, along with each frame's result flag from the voice/noise discriminator 23g. If the talkspurt flag is set, the transmitter 25 sends out both the coded data stream and flag. If the noise flag is set, it only sends the flag.

Mobile handsets generally consume a large amount of electricity when transmitting radiowave signals. The above-described VOX system 20 reduces power consumption by disabling transmission of coded data when the input signal contains nothing but noise. The present invention permits accurate discrimination between voice and noise and thus prevents talkspurt frames from being misclassified as noise frames. This feature of the invention makes clipping-free voice transmission possible, thus contributing to improved sound quality in mobile communication.

### Noise Canceller Applications

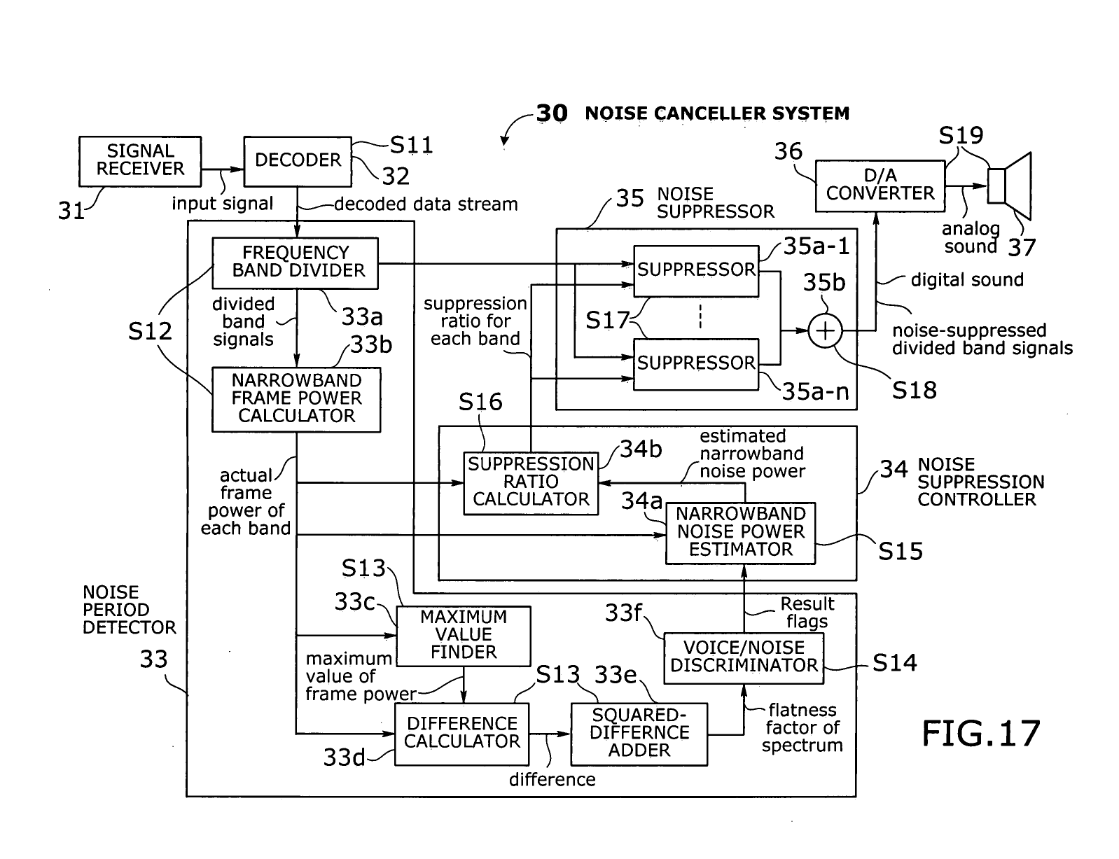

This section describes noise canceller systems as another application of the present invention. FIG. 17 shows the structure of a noise canceller system according to the present invention. Communications equipment has a noise canceller to reduce background noise components in an input signal, so as to improve the clarity of voice. In this technical field, the voice activity detection function of the present invention can be applied in switching between noise training and noise suppression; i.e., it identifies noise components at step (n-1) and uses that components to eliminate noise in the signal at step (n).

The noise canceller system 30 of FIG. 17 has bandpass filters to split the frequency band and is designed to use the algorithm of equation (12) to evaluate spectral flatness. This system 30 comprises the following elements: a signal receiver 31, a decoder 32, a noise period detector 33, a noise suppression controller 34, a noise suppressor 35, a digital-to-analog (D/A) converter 36, and a loudspeaker 37. Note that the voice activity detector 10 (FIG. 1) of the present invention is implemented in the noise period detector 33, which comprises a frequency band divider 33a, a narrowband frame power calculator 33b, a maximum value finder 33c, a difference calculator 33d, a squared-difference adder 33e, and a voice/noise discriminator 33f. The noise suppression controller 34 comprises a narrowband noise power estimator 34a and a suppression ratio calculator 34b. The noise suppressor 35 comprises a plurality of suppressors 35a-1 to 35a-n and an adder 35b.

To be more specific about the relationship between FIG. 1 and FIG. 17, the frequency band divider 33a and narrowband frame power calculator 33b provide the functions of the frequency spectrum calculator 11. The maximum value finder 33c, difference calculator 33d, and squared-difference adder 33e serve as the flatness evaluator 12. Further, the voice/noise discriminator 33f is equivalent to the voice/noise discriminator 13.

The noise canceller system 30 of FIG. 17 operates as follows:
(S11) The signal receiver 31 supplies a coded data stream to the decoder 32 for decoding. The decoded data is then passed to the noise period detector 33.
(S12) The frequency band divider 33a divides each given frame signal into a plurality of signals in different narrow frequency bands. The narrowband frame power calculator 33b calculates the frame power of each band, thus obtaining a power spectrum.
(S13) The maximum value finder 33c finds the maximum power level according to equation (10). Then, according to equation (12), the difference calculator 33d calculates the absolute values of differences between individual spectral components and the maximum power level. The squared-difference adder 33e adds up the square of each calculated difference, thus outputting the resulting sum of squared differences as a flatness factor.
(S14) The voice/noise discriminator 33f compares the flatness factor of each frame with a predetermined threshold. Through this comparison the voice/noise discriminator 33f determines whether the frame in question is speech or noise, and it sets an appropriate flag to indicate the result.
(S15) The narrowband noise power estimator 34a is activated only when a noise flag is set by the voice/noise discriminator 33f. When activated, it estimates how much noise power is contained in each narrow frequency band, thus yielding a narrowband noise power level. Such estimation is achieved by, for example, averaging the power levels of past frames that were determined to be background noises.
(S16) The suppression ratio calculator 34b determines how much suppression is needed in each frequency band, by comparing the measured frame power of each frequency band (output of the narrowband frame power calculator 33b) with the estimated narrowband noise power (output of the narrowband noise power estimator 34a). For example, it specifies 15 dB suppression for frequency bands in which the actual frame power is lower than the estimated narrowband noise power, while giving no suppression (0 dB) to the other frequency bands.
(S17) The suppressors 35a-1 to 35a-n selectively reduce noise components in the input signal by multiplying their respective frequency band signals supplied from the frequency band divider 33a by the corresponding suppression ratios that the suppression ratio calculator 34b specifies.
(S18) The adder 35b combines all the noise-suppressed frequency band signals into a single signal.
(S19) The D/A converter 36 converts the outcome of the adder 35b from digital form to analog form, so that the loudspeaker 37 outputs a reproduced speech signal as audible sound.

As can be seen from the above explanation, the proposed noise canceller system 30 involves a speech/noise separation process with a high degree of accuracy, which prevents speech frames from being mistakenly suppressed as noise frames. Besides offering enhanced performance of noise suppressing functions without sacrificing the accuracy of noise training, it prevents the speech signal from being overly suppressed or clipped. This feature of the invention will contribute to improved quality of communication.

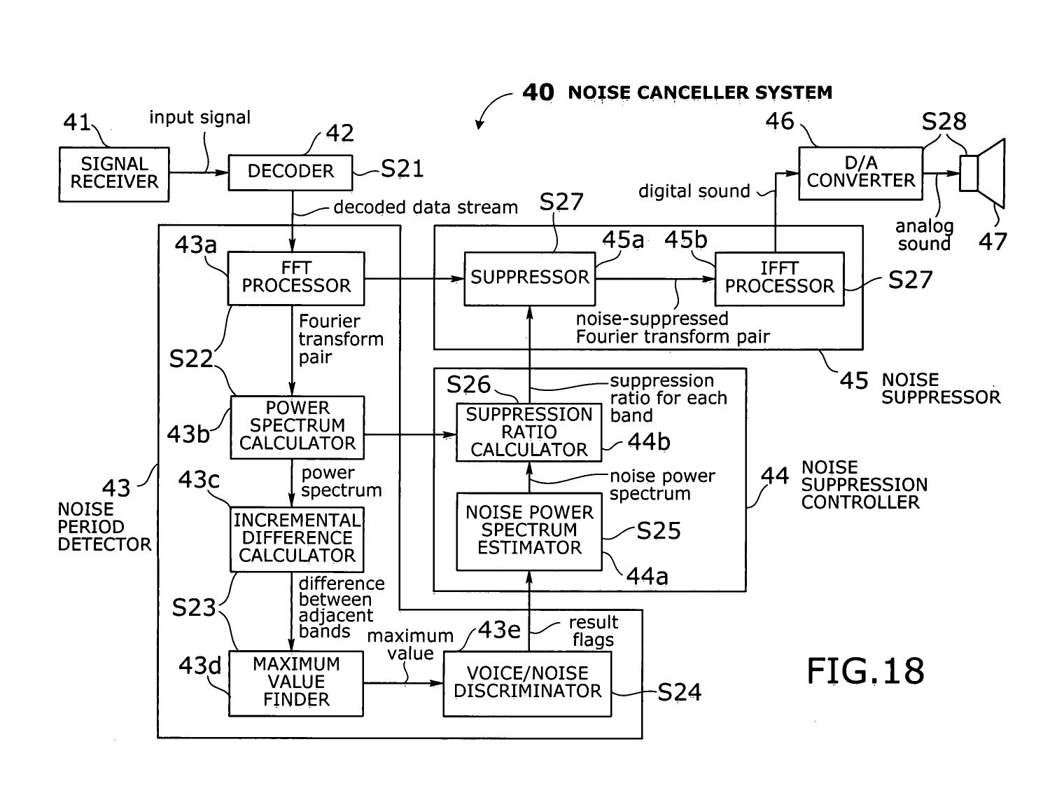

FIG. 18 shows the structure of another noise canceller system 40, which uses FFT techniques to calculate the power spectrum of a given frame, as well as applying equation (15) to evaluate the flatness of that spectrum. The illustrated noise canceller system 40 comprises a signal receiver 41, a decoder 42, a noise period detector 43, a noise suppression controller 44, a noise suppressor 45, a D/A converter 46, and a loudspeaker 47. Note that the voice activity detector 10 (FIG. 1) of the present invention is implemented in the noise period detector 43. The noise period detector 43 comprises an FFT processor 43a, a power spectrum calculator 43b, an incremental difference calculator 43c, a maximum value finder 43d, and a voice/noise discriminator 43e. The noise suppression controller 44 comprises a noise power spectrum estimator 44a and a suppression ratio calculator 44b. The noise suppressor 45 comprises a suppressor 45a and an inverse fast Fourier transform (IFFT) processor 45b.

To be more specific about the relationship between FIG. 1 and FIG. 18, The FFT processor 43a and power spectrum calculator 43b provide the functions of the frequency spectrum calculator 11. The incremental difference calculator 43c and maximum value finder 43d serve as the flatness evaluator 12. The voice/noise discriminator 43e is equivalent to the voice/noise discriminator 13.

The noise canceller system 40 of FIG. 18 operates as follows:
(S21) The signal receiver 41 supplies a coded data stream to the decoder 42 for decoding. The decoded data is then sent to the noise period detector 43.
(S22) The FFT processor 43a analyzes each frame of a given input signal by using FFT algorithms, thus decomposing it into individual frequency components. The power spectrum calculator 43b produces a power spectrum by calculating the power of frequency components of each input signal frame.
(S23) According to equation (15), the incremental difference calculator 43c calculates the differences between adjacent spectral components. The maximum value finder 43d finds the maximum among those differences, thus outputting the maximum difference as a flatness factor.
(S24) The voice/noise discriminator 43e compares the flatness factor of each frame with a predetermined threshold. With this comparison, the voice/noise discriminator 43e determines whether the frame in question is speech or noise, and it sets an appropriate flag to indicate the result.
(S25) When a noise flag is set by the voice/noise discriminator 43e, the noise power spectrum estimator 44a updates its estimated noise power spectrum.
(S26) The suppression ratio calculator 44b determines how much suppression is needed in each frequency component, by comparing the present frame's power spectrum with the estimated noise power spectrum.
(S27) The suppressor 45a selectively reduce noise components in the input signal by multiplying each frequency component (i.e., output of the frequency band divider 33a) by a suppression ratio determined by the suppression ratio calculator 44b. The IFFT processor 45b then performs inverse Fourier transform on the noise-suppressed Fourier transform pair.
(S28) The D/A converter 46 converts the digital output of the IFFT processor 45b into analog form, so that the loudspeaker 47 outputs a reproduced speech signal as audible sound.

### Tone Detector Applications

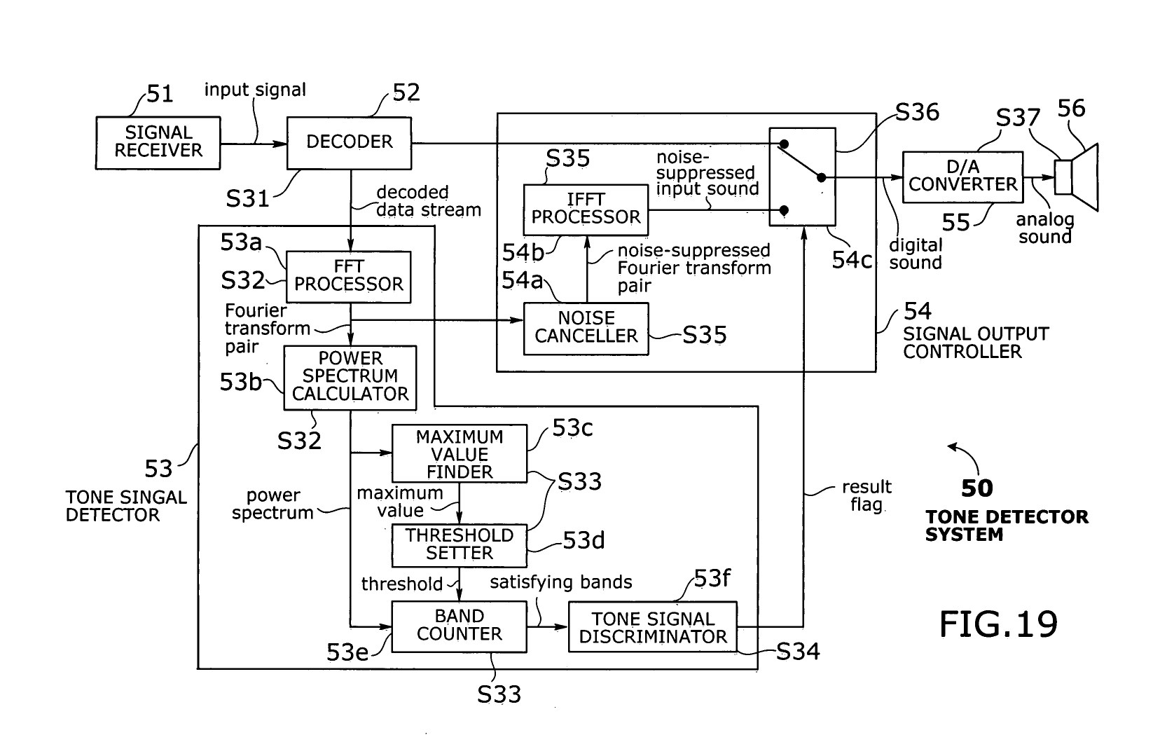

Referring to FIG. 19, this section describes a tone detector system as yet another application of the present invention. A tone detector finds tone signal components in a given input signal, and if such a component is present, it passes the signal as is. If no tones are detected, it subjects the signal to a noise canceller or other speech processing. Tone detectors handle dual tone multiple frequency (DTMF) signals and facsimile signals in this way.

FIG. 19 shows the structure of a tone detector system 50, which uses FFT to calculate the power spectrum of a given signal and evaluates the flatness of that spectrum according to equation (18). This tone detector system 50 comprises the following elements: a signal receiver 51, a decoder 52, a tone signal detector 53, a signal output controller 54, and a D/A converter 55 and a loudspeaker 56. The tone signal detector 53 comprises an FFT processor 53a, a power spectrum calculator 53b, a maximum value finder 53c, a threshold setter 53d, a band counter 53e, and a tone signal discriminator 53f. The signal output controller 54 comprises a noise canceller 54a, an IFFT processor 54b and a switch 54c.

Many of the elements shown in FIG. 19 relate to the voice activity detector 10 described earlier in FIG. 1. More specifically, the FFT processor 53a and power spectrum calculator 53b provide the functions of the frequency spectrum calculator 11. The maximum value finder 53c, threshold setter 53d, and band counter 53e serve as the flatness evaluator 12, while the tone signal discriminator 53f corresponds to the voice/noise discriminator 13.

The tone detector system 50 of FIG. 19 operates as follows:
(S31) The signal receiver 51 supplies a coded data stream to the decoder 52 for decoding. The decoded data is then sent to the tone signal detector 53.
(S32) The FFT processor 53a analyzes each input signal frame by using FFT algorithms, thus decomposing it into individual frequency components. The power spectrum calculator 53b produces a power spectrum by calculating the power of those individual frequency components.
(S33) The maximum value finder 53c finds a maximum power level according to equation (10), and based on this maximum value, the threshold setter 53d determines a threshold according to either equation (19a) or (19b). The band counter 53e counts the number of such frequency components that exceed the threshold, according to equation (18). The obtained number is used as a flatness factor.
(S34) The tone signal discriminator 53f compares the flatness factor of each frame with a predetermined threshold, thus determining whether the frame in question contains a tone signal or not. The tone signal discriminator 53f then sets an appropriate flag to indicate the result.
(S35) The noise canceller 54a applies a noise canceling process to the frequency-domain signal output of the FFT processor 53a, thus suppressing unwanted noise components in each given signal frame. The IFFT processor 54b performs inverse Fourier transform on the noise-suppressed Fourier transform pair, thereby reproducing a time-domain sound signal.
(S36) If the result flag indicates the presence of a tone signal, the switch 54c selects the output of the decoder 52. Otherwise, it select the output of the IFFT processor 54b.
(S37) The D/A converter 55 converts the digital output of the switch 54c to analog form, so that the loudspeaker 56 can output the speech signal as audible sound.

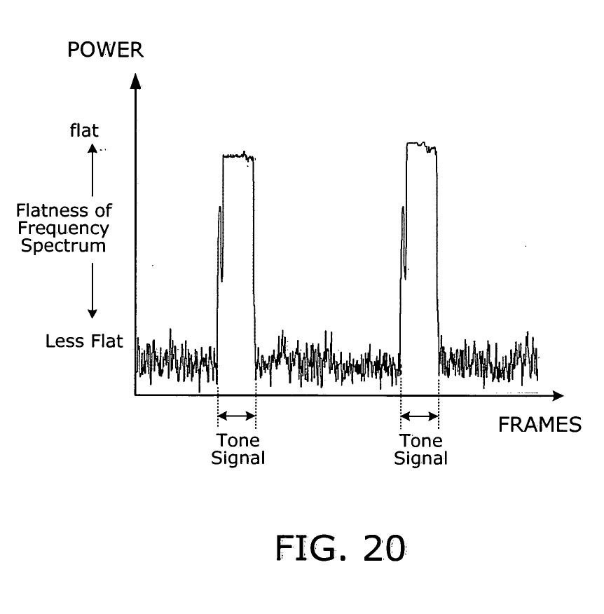

FIG. 20 shows an example waveform containing tone signals, where the horizontal axis represents frames (time) and the vertical axis represents signal power. The present invention enables tone signals to be identified accurately as shown in FIG. 20, since they obviously have a weaker spectral flatness.

### Echo Canceller Applications

This section describes how the present invention is applied to echo canceller systems. Echo cancellers are used in full-duplex communication systems to prevent output sound from being coupled back to the input end acoustically or electrically, thus eliminating unwanted echo or howling effects.

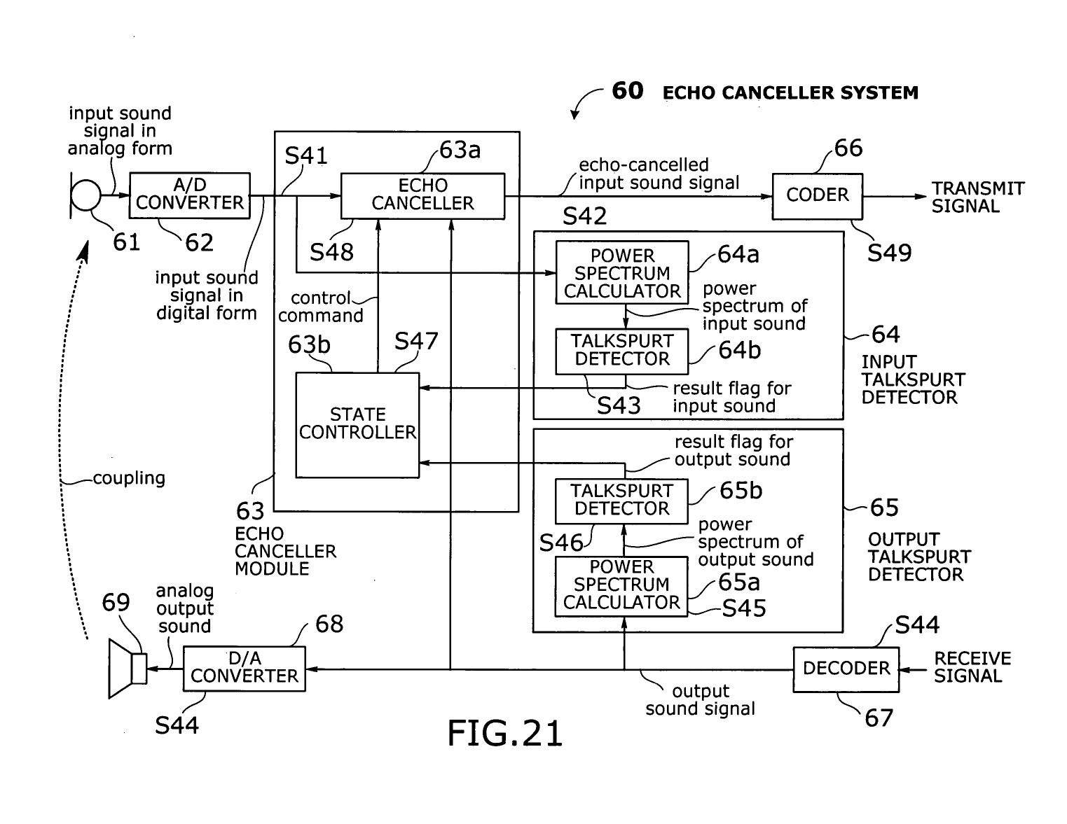

FIG. 21 shows the structure of an echo canceller system according to the present invention. The illustrated echo canceller system 60 comprises a microphone 61, an A/D converter 62, an echo canceller module 63, an input talkspurt detector 64, an output talkspurt detector 65, a coder 66, a decoder 67, a D/A converter 68, and a loudspeaker 69. Note that the voice activity detector 10 (FIG. 1) of the present invention is implemented in the input talkspurt detector 64 and output talkspurt detector 65. The echo canceller module 63 comprises an echo canceller 63a and a state controller 63b. The input talkspurt detector 64 comprises a power spectrum calculator 64a and a talkspurt detector 64b, and similarly, the output talkspurt detector 65 comprises a power spectrum calculator 65a and a talkspurt detector 65b.

To be more specific about the relationship between FIG. 1 and FIG. 21, the power spectrum calculator 64a in the input talkspurt detector 64 works as the frequency spectrum calculator 11, and the talkspurt detector 64b provides the functions of the flatness evaluator 12 and voice/noise discriminator 13. Also, the power spectrum calculator 65a in the output talkspurt detector 65 works as the frequency spectrum calculator 11, and the talkspurt detector 65b provides the functions of the flatness evaluator 12 and voice/noise discriminator 13.

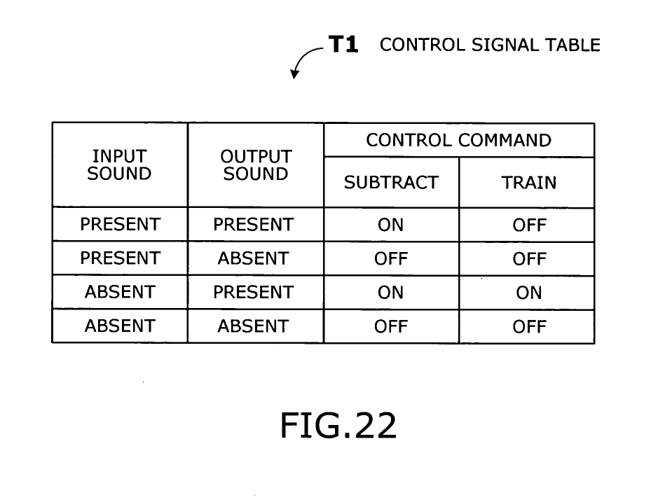

The echo canceller system 60 of FIG. 21 operates as follows:
(S41) The microphone 61 supplies a voice input signal to the A/D converter 62. The A/D converter 62 converts this input signal into digital form and delivers it to the echo canceller 63a and power spectrum calculator 64a.
(S42) The power spectrum calculator 64a applies FFT on the input sound signal and supplies the resulting power spectrum to the talkspurt detector 64b.
(S43) The talkspurt detector 64b evaluates the flatness of the given power spectrum, thus determining whether the frame in question is a talkspurt. The talkspurt detector 64b sends a result flag (input sound flag) to the state controller 63b to indicate whether the input sound signal contains speech or not.
(S44) The decoder 67 decodes a sound signal (coded data stream) received from a remote end (not shown) and distributes the resulting output sound signal to the power spectrum calculator 65a, echo canceller 63a, and D/A converter 68. The D/A converter 68 converts the signal into analog form, so that the loudspeaker 69 can output it as audible sound.
(S45) The power spectrum calculator 65a calculates the power spectrum of the output sound signal for use in the subsequent talkspurt detector 65b.
(S46) The talkspurt detector 65b evaluates the flatness of the given power spectrum, thus determining whether the frame in question is a talkspurt. The talkspurt detector 64b sends a result flag (output sound flag) to the state controller 63b to indicate the whether the output sound signal contains speech or not.
(S47) The state controller 63b monitors the input and output sound flags and gives an appropriate control command to the echo canceller 63a, consulting a control signal table T1 shown in FIG. 22.
(S48) When a subtract command is given, the echo canceller 63a produces a pseudo echo signal by applying estimated echo path characteristics to the output sound and subtracts that pseudo echo signal from the input sound signal. When, on the other hand, a train command is received, the echo canceller 63a updates the echo path characteristics with reference to the echo-cancelled signal. The updated echo path characteristics is to be used next time the echo canceller 63a produces a pseudo echo signal.
(S49) The coder 66 encodes the echo-cancelled sound signal for transmission to the remote end.

As can be seen from the above explanation, the proposed echo canceller system 60 identifies accurately the state of input and output sound signals so as to control echo cancellation and training processes. It prevents the sound signals from suffering unwanted artifacts or being clipped due to incorrect signal recognition. This feature of the echo canceller system 60 contributes to improved quality of calls.

In summary, the present invention uses the flatness of frequency spectrums as the metrics for determining whether a signal frame contains speech information or noise, making it possible to accurately detect talkspurts in a given signal with simple computation. This spectrum-based voice activity detection works reliably and effectively even when the speech signal is small in power, or when the energy of noises is relatively high. Implementation of the proposed method is particularly easy in such applications as noise cancellers, because those devices inherently have speech processing functions including a time-frequency transform (i.e., the frequency spectrum of an input signal is already available).

We have proposed various algorithms for flatness determination, based on the same key concept of the present invention. While those algorithms evaluate the power spectrum of a given signal, i.e., the distribution of power of different frequency components, we would like to note here that the use of amplitude spectrum (instead of power spectrum) will also achieve the purpose of the invention. Where appropriate, we have used the term “frequency spectrum” in this sense, conveying the concept of both power spectrum and amplitude spectrum. Accordingly, voice activity detectors, voice-operated transmitters, noise cancellers, tone detectors, and voice activity detection methods that use any of the proposed algorithms, but with amplitude spectrums, are also supposed to fall within the scope of the present invention.

While we have demonstrated that the proposed voice activity detector can be used in VOX devices, noise cancellers, tone detectors, and echo cancellers, we do not intend to limit the present invention to those particular applications. Those skilled in the art will appreciate that the present invention can also be applied to various devices that involve speech processing functions.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A voice activity detector that detects talkspurts in an input signal, comprising:
a frequency spectrum calculator that calculates frequency spectrum of the input signal;
a flatness evaluator that calculates a flatness factor indicating flatness of the frequency spectrum; and
a voice/noise discriminator that determines whether the input signal contains a talkspurt, by comparing the flatness factor of the frequency spectrum with a predetermined threshold.

2. The voice activity detector according to claim 1, wherein:
the input signal is provided on a frame basis; and
said frequency spectrum calculator comprises either a spectral analyzer that analyzes the given signal frame in frequency domain, or a plurality of bandpass filters that divide the given signal frame into individual frequency components so as to calculate power of each frequency component.

3. The voice activity detector according to claim 1, wherein said flatness evaluator calculates an average of spectral components of the input signal, adds up differences between the spectral components and the average thereof, and uses the resulting sum of the differences as the flatness factor of the frequency spectrum.

4. The voice activity detector according to claim 1, wherein said flatness evaluator calculates an average of spectral components of the input signal, adds up squared differences between the spectral components and the average thereof, and uses the resulting sum of the squared differences as the flatness factor of the frequency spectrum.

5. The voice activity detector according to claim 1, wherein said flatness evaluator calculates an average of spectral components of the input signal, finds a maximum difference between the spectral components and the average thereof, and uses the maximum difference as the flatness factor of the frequency spectrum.

6. The voice activity detector according to claim 1, wherein said flatness evaluator finds a maximum value of the frequency spectrum, adds up differences between spectral components and the maximum value thereof, and uses the resulting sum of the differences as the flatness factor of the frequency spectrum.

7. The voice activity detector according to claim 1, wherein said flatness evaluator finds a maximum value of the frequency spectrum, adds up squared differences between spectral components and the maximum value, and uses the resulting sum of the squared differences as the flatness factor of the frequency spectrum.

8. The voice activity detector according to claim 1, wherein said flatness evaluator finds a maximum value of the frequency spectrum, finds a maximum difference between spectral components and the maximum value, and uses the maximum difference as the flatness factor of the frequency spectrum.

9. The voice activity detector according to claim 1, wherein said flatness evaluator adds up differences between adjacent spectral components of the input signal and uses the resulting sum of the differences as the flatness factor of the frequency spectrum.

10. The voice activity detector according to claim 1, wherein said flatness evaluator finds a maximum difference between adjacent spectral components of the input signal and uses the maximum difference as the flatness factor of the frequency spectrum.

11. The voice activity detector according to claim 1, wherein said flatness evaluator calculates an average of spectral components of the input signal and normalizes the flatness factor by dividing by the calculated average.

12. The voice activity detector according to claim 1, wherein:
the input signal is provided on a frame basis; and
said flatness evaluator calculates average power of the given signal frame and normalizes the flatness factor by dividing by the calculated average power.

13. The voice activity detector according to claim 1, wherein said flatness evaluator calculates an average of spectral components of the input signal, determines a threshold from the average, counts the number of spectral components that exceed the threshold, and uses the resulting number as the flatness factor of the frequency spectrum.

14. The voice activity detector according to claim 1, wherein said flatness evaluator finds a maximum value of the frequency spectrum, determines a threshold from the maximum value, counts the number of spectral components that exceed the threshold, and uses the resulting number as the flatness factor of the frequency spectrum.

15. A voice-operated transmitter that turns on and off transmission signal output depending on whether a speech signal is present or not, the transmitter comprising:
(a) a talkspurt detector comprising:
a frequency spectrum calculator that calculates frequency spectrum of an input signal,
a flatness evaluator that calculates a flatness factor indicating flatness of the frequency spectrum, and
a voice/noise discriminator that determines whether the input signal contains a talkspurt, by comparing the flatness factor of the frequency spectrum with a predetermined threshold, and sets a talkspurt flag for a talkspurt period or a noise flag for a noise period;
(b) an encoder that produces a coded data stream by encoding the input signal; and
(c) a transmitter that transmits both the coded data stream and talkspurt flag when the talkspurt flag is set, and transmits only the noise flag when the noise flag is set.

16. A noise canceller that suppresses noise components in an input signal, comprising:
(a) a noise period detector, comprising:
a plurality of bandpass filters that divides the input signal into a plurality of frequency components,
a frequency spectrum calculator that calculates frequency spectrum of the input signal by processing the frequency components supplied from said bandpass filters,
a flatness evaluator that calculates a flatness factor indicating flatness of the frequency spectrum, and
a voice/noise discriminator that determines whether the input signal contains a talkspurt, by comparing the flatness factor of the frequency spectrum with a predetermined threshold, and sets a talkspurt flag for a talkspurt period or a noise flag for a noise period;
(b) a suppression ratio calculator that estimates noise power of each frequency component when the noise flag is set, and determines a suppression ratio for each frequency component, based on frame power of each frequency component and the estimated noise power; and
(c) a noise suppressor that selectively reduces noise components in the input signal by suppressing the individual frequency components according to the suppression ratios determined by said suppression ratio calculator.

17. A noise canceller that suppresses noise components in an input signal, comprising:
(a) a noise period detector, comprising:
a spectrum analyzer that calculates frequency spectrum of the input signal through spectral analysis,
a flatness evaluator that calculates a flatness factor indicating flatness of the frequency spectrum, and
a voice/noise discriminator that determines whether the input signal contains a talkspurt, by comparing the flatness factor of the frequency spectrum with a predetermined threshold, and sets a talkspurt flag for a talkspurt period or a noise flag for a noise period;
(b) a suppression ratio calculator that estimates a noise power spectrum of noise components in the input signal when the noise flag is set, and determines a suppression ratio for each frequency component, based on the estimated noise power spectrum and the frequency spectrum of the input signal; and
(c) a noise suppressor that selectively reduces noise components in the input signal by suppressing the frequency components according to the suppression ratios determined by said suppression ratio calculator.

18. A tone detector that detects tone signal components in an input signal, comprising:
(a) a tone signal detector, comprising:
a frequency spectrum calculator that calculates frequency spectrum of the input signal,
a flatness evaluator that calculates a flatness factor indicating flatness of the frequency spectrum, and
a tone signal discriminator that determines whether the input signal contains a tone signal, by comparing the flatness factor of the frequency spectrum with a predetermined threshold, and sets a tone detection flag to indicate that a tone signal is present;
(b) a decoder that produces a decoded data stream by decoding the input signal; and
(c) a signal output controller that outputs the decoded data stream as is when the tone detection flag is set, and applies speech processing to the decoded data before outputting when the tone detection flag is not set.

19. An echo canceller that prevents echoes from occurring, comprising:
(a) an input talkspurt detector, comprising:
an input sound frequency spectrum calculator that calculates frequency spectrum of an input sound signal,
an input sound flatness evaluator that calculates a flatness factor indicating flatness of the input sound frequency spectrum, and
an input voice/noise discriminator that determines whether the input sound signal contains a talkspurt, by comparing the flatness factor of the input sound frequency spectrum with a predetermined threshold, and sets an input sound flag to indicate presence of a talkspurt in the input sound signal;
(b) an output talkspurt detector, comprising:
an output sound frequency spectrum calculator that calculates frequency spectrum of an output sound signal,
an output sound flatness evaluator that calculates a flatness factor indicating flatness of the output sound frequency spectrum, and
an output voice/noise discriminator that determines whether the output sound signal contains a talkspurt, by comparing the flatness factor of the output sound frequency spectrum with a predetermined threshold, and sets an output sound flag to indicate presence of a talkspurt in the output sound signal; and
(c) an echo canceller module that identifies states of the input and output sound signals by monitoring the input and output sound flags, and performing either a subtraction process or an echo training process depending on the identified states, wherein the subtraction process produces a pseudo echo signal by applying echo path characteristics on the output sound signal and subtracts the produced pseudo echo signal from the input sound signal, and wherein the echo canceling process updates the echo path characteristics.

20. A voice activity detection method for detecting talkspurts in an input signal, comprising the steps of:
(a) calculating frequency spectrum of the input signal;
(b) calculating a flatness factor indicating flatness of the frequency spectrum; and
(c) determining whether the input signal contains a talkspurt, by comparing the flatness factor of the frequency spectrum with a predetermined threshold.

21. The voice activity detection method according to claim 20, wherein:
the: input signal is provided on a frame basis; and
said spectrum calculating step (a) comprises one of the substeps of:
analyzing the input signal frame in frequency domain, and
dividing the input signal frame into individual frequency components by using a plurality of bandpass filters, and calculating power of each frequency component.

22. The voice activity detection method according to claim 20, wherein:
said flatness calculating step (b) comprises the substep of calculating an average value of spectral components of the input signal; and
said flatness calculating step (b) further comprises one of the substeps of:
adding up differences between the spectral components and the average value,
adding up squared differences between the spectral components and the average value, and
finding a maximum difference between the spectral components and the average value.

23. The voice activity detection method according to claim 20, wherein
said flatness calculating step (b) comprises the substep of finding a maximum value of spectral components of the input signal; and
said flatness calculating step (b) further comprises one of the substeps of:
adding up differences between the spectral components and the maximum value,
adding up squared differences between the spectral components and the maximum value, and
finding a maximum difference between the spectral components and the maximum value.

24. The voice activity detection method according to claim 20, wherein said flatness calculating step (b) comprises one of the substeps of:
adding up differences between adjacent spectral components of the input signal; and
finding a maximum difference between adjacent spectral components of the input signal.

25. The voice activity detection method according to claim 20, wherein:
the input signal is provided on a frame basis; and
said flatness calculating step (b) comprises one of the substeps of:
normalizing the flatness factor by dividing by an average value of spectral components of the input signal; and
normalizing the flatness factor by dividing by average power of the input signal frame.

26. The voice activity detection method according to claim 20, wherein said flatness calculating step (b) comprises the substeps of:
calculating an average value of spectral components of the input signal;
determining a threshold from the average value;
counting the number of spectral components that exceed the threshold; and
assigning the resulting number as the flatness factor of the frequency spectrum.

27. The voice activity detection method according to claim 20, wherein said flatness calculating step (b) comprises the substeps of:
calculating a maximum value of spectral components of the input signal;
determining a threshold from the maximum value;
counting the number of spectral components that exceed the threshold; and
assigning the resulting number as the flatness factor of the frequency spectrum.
